(19) United States
(12) Patent Application Publication
(10) Pub. No.: US 2024/0328020 A1
(43) Pub. Date: Oct. 3, 2024

(54) METHOD FOR RECOVERING VALUABLE METAL ELEMENTS FROM COPPER-CONTAINING METALLIC MATERIAL

(71) Applicant: National Tsing Hua University, Hsinchu City (TW)

(72) Inventors: Chih-Huang LAI, Hsinchu City (TW); Zheng-Yu CHEN, Hsinchu City (TW); Tzu-Min CHENG, Tainan City (TW)

(21) Appl. No.: 18/342,442

(22) Filed: Jun. 27, 2023

(30) Foreign Application Priority Data
Mar. 30, 2023 (TW) 112112207

(51) Int. Cl. C25C 1/12; C25B 1/01; C25B 9/67; C25C 7/06

(52) U.S. Cl. CPC C25C 1/12; C25B 1/01; C25B 9/67; C25C 7/06

(57) ABSTRACT

A method for recovering valuable metal elements from a copper-containing metallic material includes steps of: (a) immersing an anode and the copper-containing metallic material serving as a cathode into an electrolyte solution having one of an acidic pH and an alkaline pH; and (b) providing a predetermined voltage to the anode and the cathode such that an electrolysis process conducted under the predetermined voltage on the cathode forms a gaseous film surrounding the cathode, and then the gaseous film is broken down to permit generation of a plasma in the electrolyte solution so as to obtain a solid copper metal or a solid copper oxide that precipitates from the electrolyte solution, and ionic impurities that dissolve in the electrolyte solution.

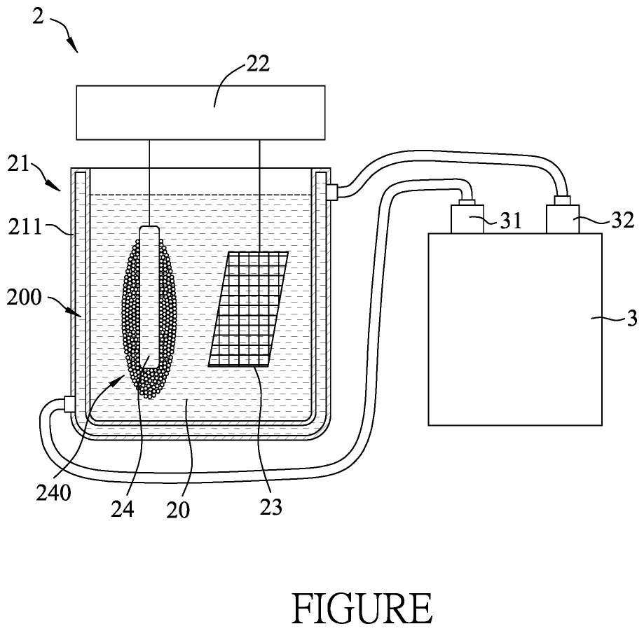

### CROSS-REFERENCE TO RELATED APPLICATION

This application claims priority to Taiwanese Invention Patent Application No. 112112207, filed on Mar. 30, 2023.

### FIELD

The present disclosure relates to a method for recovering valuable metal elements, and more particularly to a method for recovering valuable metal elements from a copper-containing metallic material.

### BACKGROUND

Copper is a metal with excellent ductility, high thermal conductivity, and high electrical conductivity, and thus, is widely used in various fields, and has become one of the most important metals in industry. In comparison to other metals commonly used in the industry (e.g., iron and aluminum), copper has a very low reserves-to-production ratio (that is, a low reserve life span), and due to other issues such as depletion of mineral resources, difficulty in mining techniques, high production cost, etc., more industries are willing to choose recycled copper material for industrial use.

A conventional method for separating and recovering copper from a copper-containing metallic material includes a first step and a second step which are conducted in sequence. In the first step, the copper-containing metallic material is subjected to purification using a hydrometallurgy technique or a pyrometallurgy technique to obtain a purified copper; however, the thus obtained purified copper has a relatively low purity (e.g., <99 wt %). Thereafter, the second step is conducted in which the purified copper is subjected to refinement using an electrorefining technique so as to obtain a refined copper having a purity of approximately 99.99 wt %.

With regard to the hydrometallurgy technique, such technique includes dissolution process using acids and extraction process, which require use of toxic, organic extracting agents with high consumption of chemicals, along with a relatively long time period of reaction.

As to the pyrometallurgy technique, such technique involves use of high-temperature melting process for separating metal elements based on their physical properties, which requires large energy consumption (i.e., approximately 16000 J/g), and since certain metal elements might exist in the form of alloys due to similar physical properties, an optimal separation effect may not be achieved.

In the electrorefining technique, the difference in the electrical potential of the metal elements is used as a basis in separation of such metal elements. Although the metal elements separated using the electrorefining technique have high purity, such technique is only suitable for metal elements with low content of impurities due to difficulty in separating metal elements having similar electrochemical potential.

Based on the aforesaid description, those skilled in the art strive to reduce the use of toxic, organic extracting agents so as to reduce the cost of chemicals, and to reduce energy consumption required in the recovery of metal elements, such as copper, from the copper-containing metallic material.

### SUMMARY

Therefore, an object of the present disclosure is to provide a method for recovering valuable metal elements from a copper-containing metallic material that can alleviate at least one of the drawbacks of the prior art.

According to the present disclosure, the method includes the steps of:
(a) immersing an anode and the copper-containing metallic material serving as a cathode into an electrolyte solution having one of an acidic pH and an alkaline pH; and
(b) providing a predetermined voltage to the anode and the cathode such that an electrolysis process conducted under the predetermined voltage on the cathode forms a gaseous film surrounding the cathode, and then the gaseous film is broken down to permit generation of a plasma in the electrolyte solution so as to obtain a solid copper metal or a solid copper oxide that precipitates from the electrolyte solution, and ionic impurities that dissolve in the electrolyte solution,
wherein in step (b), the solid copper metal precipitates from the electrolyte solution when the electrolyte solution has the acidic pH, and
wherein in step (b), the solid copper oxide precipitates from the electrolyte solution when the electrolyte solution has the alkaline pH.

### BRIEF DESCRIPTION OF THE DRAWINGS

Other features and advantages of the present disclosure will become apparent in the following detailed description of the embodiment(s) with reference to the accompanying drawings. It is noted that various features may not be drawn to scale.

The FIGURE is a schematic view illustrating a metal separation assembly used in the implementation of the method for recovering valuable metal elements from a copper-containing metallic material according to the present disclosure.

### DETAILED DESCRIPTION

Before the present disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

The present disclosure provides a method for recovering valuable metal elements from a copper-containing metallic material which is implemented using a metal separation assembly 2 as shown in the FIGURE. The metal separation assembly 2 includes a reaction tank 21 containing an electrolyte solution 20, an anode 23 and a cathode 24 immersed into the electrolyte solution 20, a power supply 22 electrically connected to the anode 23 and the cathode 24, and a temperature-controlled water circulation device 3 connected to the reaction tank 21.

The reaction tank 21 has a double-layered surrounding wall 211, which defines a peripheral space 200 capable of circulating a cooling water. The peripheral space 200 is connected to the temperature-controlled water circulation device 3, so that the cooling water can circulate back and forth therebetween and so that the temperature-controlled water circulation device 3 can control a temperature of the cooling water. In certain embodiments, the temperature-controlled water circulation device 3 is a water cooler.

To be specific, the temperature-controlled water circulation device 3 has a water inlet 31 and a water outlet 32 each in communication with the peripheral space 200 through a water pipe. After the temperature-controlled water circulation device 3 lowers the temperature of the cooling water, i.e., the cooling water has a relatively low temperature, such cooling water is introduced into the peripheral space 200 through the water outlet 31 to absorb the heat from the electrolyte solution 20 that has a high temperature due to implementation of the method of the present disclosure, and then the cooling water having a relatively high temperature due to absorption of heat in the peripheral space 200 is introduced back into the temperature-controlled water circulation device 3 through the water inlet 32 to be cooled, followed by again introducing the cooling water having a relatively low temperature into the peripheral space 200 through the water outlet 31, so that the temperature of the peripheral space 200 is maintained at a relatively low temperature by the cooling water which circulates back and forth between the temperature-controlled water circulation device 3 and the peripheral space 200, thereby enabling control of the temperature of the electrolytic solution 20 with the presence of the cooling water in the peripheral space 200.

An embodiment of the method for recovering valuable metal elements from a copper-containing metallic material of the present disclosure includes steps (a) to (c).

In step (a), the anode 23 and the copper-containing metallic material serving as a cathode 24 are immersed into the electrolyte solution 20 having one of an acidic pH and an alkaline pH. In certain embodiments, the copper-containing metallic material is one of a brass material containing impurities and a pure copper material containing impurities. In certain embodiments, the impurities include zinc (Zn), iron (Fe), lead (Pb), and nickel (Ni).

In step (b), a predetermined voltage is provided from the power supply 22 to the anode 23 and the cathode 24 such that an electrolysis process conducted under the predetermined voltage on the cathode 24 forms a gaseous film 240 surrounding the cathode 24, and then the gaseous film 240 is broken down to permit generation of a plasma in the electrolyte solution 20, i.e., permitting a solution plasma reaction, so as to obtain a solid copper metal or a solid copper oxide that precipitates from the electrolyte solution 20, and ionic impurities that dissolve in the electrolyte solution 20. To be specific, the copper-containing metallic material serving as a cathode 24 is broken down by plasma bombardment to form copper ions, which then react with the electrolyte solution 20 so as to obtain the solid copper metal or the solid copper oxide that precipitates therefrom.

It should be noted that, in step (b), the solid copper metal precipitates from the electrolyte solution 20 when the electrolyte solution 20 has the acidic pH, whereas the solid copper oxide precipitates from the electrolyte solution 20 when the electrolyte solution 20 has the alkaline pH.

In certain embodiments, in step (a), the electrolyte solution 20 has a pH value that is one of greater than 11 and less than 5. During the electrolysis process under the predetermined voltage, in order to allow the gaseous film 240 surrounding the cathode 24 to be broken down, and to prevent the cathode 24 from melting such that the copper from the copper-containing metallic material cannot be in an ionic state, in certain embodiments, the electrolysis process is conducted at a temperature ranging from 50° C. to 90° C. by utilizing the temperature-controlled water circulation device 3, so that during the electrolysis process, the electrolyte solution 20 has the aforesaid temperature. In certain embodiments, when the electrolyte solution 20 has the pH value of greater than 11, the predetermined voltage in step (b) ranges from 70 V to 250 V, and examples of the electrolyte solution 20 may include, but are not limited to, a sodium hydroxide (NaOH) solution, a potassium hydroxide (KOH) solution, a lithium hydroxide (LiOH) solution, a cesium hydroxide (CsOH) solution, and a rubidium hydroxide (RbOH) solution. In certain embodiments, when the electrolyte solution 20 has the pH value of less than 5, the predetermined voltage in step (b) ranges from 160 V to 400 V, and examples of the electrolyte solution 20 may include, but are not limited to, a citric acid (C₆H₈O₇) solution, an acetic acid (CH₃COOH) solution, a sulfuric acid (H₂SO₄) solution, and a carbonic acid (H₂CO₃) solution.

In step (c), which is conducted after step (b), the electrolyte solution 20 is subjected to a solid-liquid separation treatment so as to collect the solid copper metal or the solid copper oxide from the electrolyte solution 20. Examples of the solid-liquid separation treatment include, but are not limited to, a centrifugation process, a sedimentation process, a vacuum concentration process, and a membrane filtration process. In an exemplary embodiment, the solid-liquid separation treatment is a centrifugation process. Examples of a membrane suitable for use in the membrane filtration process may include, but are not limited to, a microfiltration membrane, an ultrafiltration membrane, and a nanofiltration membrane.

The present disclosure will be described by way of the following examples. However, it should be understood that the following examples are intended solely for the purpose of illustration and should not be construed as limiting the present disclosure in practice.

### Example 1 (EX1)

In a method for recovering valuable metal elements from a copper-containing metallic material of EX1 includes steps (a) to (c). In step (a), a brass material containing impurities (Source: Pro Brass Metal Co., Ltd.) serving as a cathode 24 and a titanium mesh (Source: SCIKET Co., Ltd.) serving as an anode 23 were immersed into a citric acid solution which has a concentration of 1 M and a pH value of 3 and which served as an electrolyte solution 20. In step (b), a predetermined voltage of 350 V was supplied to the brass material containing impurities and the titanium mesh through a power supply 22 so as to subject the same to an electrolysis process, which was conducted at a temperature of 60° C. (i.e., the electrolyte solution 20 has a temperature of 60° C. that was maintained using the temperature-controlled water circulation device 3, which was a water cooler). During the electrolysis process, a gaseous film formed surrounding the brass material containing impurities is broken down due to the aforesaid voltage to permit generation of a plasma in the citric acid solution, i.e., permitting a solution plasma reaction, so as to obtain a solid copper metal that precipitates from the citric acid solution, and ionic impurities that dissolve in the citric acid solution. Thereafter, the solid copper metal and the citric acid solution with ionic impurities dissolved therein were subjected to a solid-liquid separation treatment using a centrifuge (not shown in FIGURE), so as to collect the solid copper metal and the ionic impurities of EX1.

The thus collected solid copper metal and ionic impurities of EX1 were analyzed using an inductively coupled plasma mass spectrometry (ICP-MS) instrument (Manufacturer: Thermo Fisher Scientific; Model no.: iCAP™ TQ), so as to determine the purity of the solid copper metal and the amount of each trace element of the ionic impurities. The results are shown in Table 1 below.

### Example 2 (EX2)

The procedures and conditions in a method for recovering valuable metal elements from a copper-containing metallic material of EX2 are substantially the same as those of EX1, except that in step (a) of the method of EX2, a pure copper containing impurities (Source: Cuprime Material Co., Ltd.) serves as the cathode 24.

The thus collected solid copper metal and ionic impurities of EX2 were subjected to analysis using the inductively coupled plasma mass spectrometry (ICP-MS) instrument, so as to determine the purity of the solid copper metal and the amount of each trace element of the ionic impurities. The results are shown in Table 1 below.

### Example 3 (EX3)

The procedures and conditions in a method for recovering valuable metal elements from a copper-containing metallic material of EX3 are substantially the same as those of EX1, except that in the method of EX3, a sodium hydroxide (NaOH) solution having a concentration of 1 M and a pH value of 14 served as the electrolyte solution 20 in step (a), and the predetermined voltage was 200 V in step (b). To be specific, in step (b), the brass material containing impurities and the NaOH solution were subjected to an electrolysis process under the predetermined voltage to form a gaseous film that surrounds the brass material containing impurities which was then broken down to permit generation of a plasma, i.e., generation of a solution plasma reaction, in the NaOH solution, so as to obtain a solid copper oxide (CuO) that precipitates from the NaOH solution, and ionic impurities that dissolve in the NaOH solution.

The thus collected solid copper oxide and ionic impurities of EX3 were subjected to analysis using the inductively coupled plasma mass spectrometry (ICP-MS) instrument, so as to determine the purity of the solid copper oxide and the amount of each trace element of the ionic impurities. The results are shown in Table 1 below.

### Example 4 (EX4)

The procedures and conditions in a method for recovering valuable metal elements from a copper-containing metallic material of EX4 are substantially the same as those of EX3, except that in step (a) of the method of EX4, a pure copper containing impurities serves as the cathode 24.

The thus collected solid copper oxide and ionic impurities of EX4 were subjected to analysis using the inductively coupled plasma mass spectrometry (ICP-MS) instrument, so as to determine the purity of the solid copper oxide and the amount of each trace element of the ionic impurities. The results are shown in Table 1 below.

TABLE 1

| | | | | | | | Valuable metal |
|---|---|---|---|---|---|---|---|
| | Ionic impurities (unit: ppm) | | | | | | element, Cu |
| Method | Zn | Pb | Fe | Sn | Ni | Others | (wt %)* |
| EX1 | 0.40 | 0.22 | 2.32 | — | 0.08 | 1.76 | 99.995 |
| EX2 | 0.46 | — | 4.00 | — | 0.72 | 11.38 | 99.993 |
| EX3 | 18.36 | — | 15.86 | — | 1.14 | 6.46 | 99.992 |
| EX4 | 0.04 | — | 17.16 | — | 1.82 | 6.86 | 99.998 |

*Valuable metal element in EX3 and EX4 refers to copper of solid copper oxide

The applicant further compares the differences in the method of the present disclosure with conventional methods for separating and recovering copper (i.e., a combination of hydrometallurgy and electrorefining techniques, and that of pyrometallurgy and electrorefining techniques) as reported in prior art documents; for example, an article by Miura S. and Honma H. entitled “Advanced copper electroplating for application of electronics” published in Surface and Coatings Technology, 2003, Vol. 169-170, p. 91-95, another article by Chen J. et al. entitled “Environmental benefits of secondary copper from primary copper based on life cycle assessment in China” published in Resources, Conservation and Recycling, 2019, Vol. 146, p. 35-44, yet another article by Deng S. et al. entitled “Evaluating economic opportunities for product recycling via the Sherwood principle and machine learning” published in Resources, Conservation and Recycling, 2021, Vol. 167, p. 105382, a book chapter by Samuelsson C. and Björkman B. entitled “Chapter 7: Copper Recycling” published in Handbook of Recycling: State-of-the-art for Practitioners, Analysts, and Scientists, 2014, p. 85-94 (taken from webpage http://dx.doi.org/10.1016/B978-0-12-396459-5.00007-6), and other published prior art documents, based on three indicators, i.e., process steps, cost of chemicals, and energy consumption.

In terms of the process steps, although the method of the present disclosure includes steps (a) to (c), the solution plasma reaction occurring in step (b) is capable of achieving the purpose of precipitating the solid copper metal or the solid copper oxide from the electrolyte solution 20, thus simplifying the overall process steps of the method. On the contrary, in the conventional methods for separating and recovering copper, the hydrometallurgy technique includes a leaching step, a first purification step, and a second purification step conducted in sequence, followed by the electrorefining technique, whereas the pyrometallurgy technique includes a smelting step, a converting step, and a fire refining step conducted in sequence, followed by the electrorefining technique, and thus, the process steps in the conventional methods for separating and recovering copper are cumbersome.

With regard to the cost of chemicals, since the method of the present disclosure only requires use of the electrolyte solution 20 having one of the acidic pH (e.g., 19.2 g of citric acid for preparing the citric acid solution) and the alkaline pH (e.g., 8 g of NaOH for preparing the NaOH solution), the cost of chemicals is low. On the contrary, in the conventional methods for separating and recovering copper, for the hydrometallurgy technique, the leaching step requires use of 25 g of ammonia (NH₃) and 36 g of ammonium chloride (NH₄Cl), the first purification step requires use of 10.5 g of hydroxyapatite (Ca₅(PO₄)₃), the second purification step requires use of 6.8 g of MgCl₂, while the electrorefining step conducted thereafter requires use of 20 ml of sulfuric acid (H₂SO₄), 20 g of copper sulfate (CuSO₄), and additives, and thus, the cost of chemicals in the conventional methods for separating and recovering copper is relatively higher compared to that of the method of the present disclosure.

Moreover, although the energy consumption during the solution plasma reaction of the method of the present disclosure, i.e., 4500 J/g, is slightly higher than that of the hydrometallurgy technique in combination with the electrorefining technique, i.e., 4300 J/g, nevertheless, such energy consumption is still much less than the total energy consumption of the pyrometallurgy technique in combination with the electrorefining technique which has a value as high as 16000 J/g (i.e., the energy consumed in the smelting step, the converting step, and the fire refining step are 9000 J/g, 1500 J/g and 1200 J/g, respectively, and in combination with 4300 J/g of the energy consumed in the electrorefining technique).

Lastly, regardless of the hydrometallurgy or pyrometallurgy technique in combination with the electrorefining technique, the copper metal separated and recovered using such techniques has a purity of 99.99 wt %; however, in the method of the present disclosure including the solution plasma reaction that is simplified, the solid copper metal or the solid copper oxide which precipitated from the electrolyte solution 20 has a purity of greater than 99.99 wt %.

In summary, by utilizing the method for recovering valuable metal elements from the copper-containing metallic material of the present disclosure, under the premise that the process steps are simplified (i.e., requiring only the solution plasma reaction in step (b)), the cost of chemicals is low, and the energy consumption is much less than that of the combination of the pyrometallurgy and electrorefining techniques, a solid copper metal or a solid copper oxide having a purity of greater than 99.99 wt % can still be obtained.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for recovering valuable metal elements from a copper-containing metallic material, comprising the steps of:
(a) immersing an anode and the copper-containing metallic material serving as a cathode into an electrolyte solution having one of an acidic pH and an alkaline pH; and
(b) providing a predetermined voltage to the anode and the cathode such that an electrolysis process conducted under the predetermined voltage on the cathode forms a gaseous film surrounding the cathode, and then the gaseous film is broken down to permit generation of a plasma in the electrolyte solution so as to obtain a solid copper metal or a solid copper oxide that precipitates from the electrolyte solution, and ionic impurities that dissolve in the electrolyte solution,
wherein in step (b), the solid copper metal precipitates from the electrolyte solution when the electrolyte solution has the acidic pH, and
wherein in step (b), the solid copper oxide precipitates from the electrolyte solution when the electrolyte solution has the alkaline pH.

2. The method as claimed in claim 1, further comprising, after step (b), a step (c) of subjecting the electrolyte solution to a solid-liquid separation treatment so as to collect the solid copper metal or the solid copper oxide from the electrolyte solution.

3. The method as claimed in claim 2, wherein in step (c), the solid-liquid separation treatment is selected from the group consisting of a centrifugation process, a sedimentation process, a vacuum concentration process, and a membrane filtration process.

4. The method as claimed in claim 1, wherein the copper-containing metallic material is selected from the group consisting of a brass material containing impurities and a pure copper material containing impurities.

5. The method as claimed in claim 4, wherein the impurities include zinc, iron, lead, and nickel.

6. The method as claimed in claim 1, wherein in step (a), the electrolyte solution has a pH value that is one of greater than 11 and less than 5.

7. The method as claimed in claim 6, wherein when the electrolyte solution has the pH value of greater than 11, the predetermined voltage in step (b) ranges from 70 V to 250 V.

8. The method as claimed in claim 7, wherein the electrolyte solution is selected from the group consisting of a sodium hydroxide solution, a potassium hydroxide solution, a lithium hydroxide solution, a cesium hydroxide solution, and a rubidium hydroxide solution.

9. The method as claimed in claim 6, wherein when the electrolyte solution has the pH value of less than 5, the predetermined voltage in step (b) ranges from 160 V to 400 V.

10. The method as claimed in claim 9, wherein the electrolyte solution is selected from the group consisting of a citric acid solution, an acetic acid solution, a sulfuric acid solution, and a carbonic acid solution.

11. The method as claimed in claim 1, wherein in step (b), the electrolysis process is conducted at a temperature ranging from 50° C. to 90° C.

12. The method as claimed in claim 11, wherein the electrolyte solution is received in a reaction tank which has a two-layered surrounding wall defining a peripheral space that permits circulation of a cooling water, the peripheral space being connected to a temperature-controlled water circulation device so that the cooling water is circulated back and forth between the temperature-controlled water circulation device and the peripheral space, and the temperature-controlled water circulation device controls a temperature of the cooling water.
